(19) United States
(12) Patent Application Publication
(10) Pub. No.: US 2013/0346143 A1
(43) Pub. Date: Dec. 26, 2013

(54) SYSTEM AND METHOD FOR SPEND ANALYSIS OF THE SERVICE CATEGORY

(71) Applicants: ALOYSIUS GREGORY SEBASTIAN, MUMBAI (IN); PRASAD NAIR, MUMBAI (IN)

(72) Inventors: ALOYSIUS GREGORY SEBASTIAN, MUMBAI (IN); PRASAD NAIR, MUMBAI (IN)

(21) Appl. No.: 13/607,711

(22) Filed: Sep. 8, 2012

(30) Foreign Application Priority Data
Jun. 21, 2012 (IN) 1774/MUM/2012

(51) Int. Cl. G06Q 30/02

(52) U.S. Cl. 705/7.29

(57) ABSTRACT

A computer based system containing Service Cost Model for spend analysis of spend category, which facilitates analysis of the service procurement cost with respect to market dynamics of labor rates for the underlying services; the system determines market trend of individual cost components i.e., primary, secondary and tertiary cost components for a service spend category based on Service Cost Model of spend analyzer module; the system comprises: a processor unit and a computer readable medium storing instructions executable by the processor unit, the computer readable medium comprising: Service Receiving System; Matching System; Associating System; Information Receiving System; and Outputting System.

### CROSS-REFERENCE TO RELATED APPLICATION

The instant application claims priority to Indian Patent Application Ser. No. 1774/MUM/2012, filed Jun. 21, 2012, pending, the entire specification of which is expressly incorporated herein by reference.

### FIELD OF THE INVENTION

This invention relates to the field of information and computation systems. Particularly, this invention relates to the field of information and computation systems in relation to service category spend. More particularly, this invention relates to procurement systems and methods facilitating spend analysis of service category.

### SUMMARY OF THE INVENTION

The present invention is related to procurement of services. The present invention provides a computer based system containing spend analyzer module. Service Cost Model of this spend analyzer module facilitates spend analysis of service category based on labor rates for key service spend categories and analysis of customer spend data with respect to it. The Service Cost Model facilitates tracking labor rates of relevant services and then associating their spend category to respective services. The present invention determines market trend for service spend category based on Service Cost Model.

An object of the present invention to provide a system and method of spend analysis of service category.

A further object of the present invention is to provide system and method to determine market trend of individual cost components, i.e., primary, secondary and tertiary cost components for a service spend category based on Service Cost Model of spend analyzer module.

The present invention provides a computer based system containing Service Cost Model for spend analysis of spend category, which facilitates analysis of the service procurement cost with respect to market dynamics of labor rates for the underlying services.

In accordance with one embodiment of the present invention, there is provided a computer based system for spend analysis of service category, comprising:

a processor unit;

a computer readable medium storing instructions executable by the processor unit, the computer readable medium comprising:

Service Receiving System for receiving a service spend category from Information Provider Module;

Matching System to match the UTC of the service spend category in Information Provider Module with the UTC or the Custom Taxonomy Code of that service spend category in spend analyzer module;

Associating System, meant for associating the weighted Service Cost Model to the service spend category based at least on one of the matching results, the Service Cost Model indicating one or more weighted cost drivers to the service spend category;

Information Receiving System for receiving information about labor rates and PPI (Producer Price Index) associated with at least a subset of the one or more weighted cost drivers in the service cost model; and associating the average market trend of the information about labor rates and PPI (Producer Price Index) of the one or more weighted cost contributors in the cost component model with the actual purchase trend of that service spend category for particular period of time; and

Outputting System for outputting an analysis of spend associated with the service spend category in relation to the weighted service cost model, based at least in part on the average market trend of the information about labor rates and PPI (Producer Price Index).

The associating system of the present system includes Selecting System for selecting a Service Cost Model from a plurality of pre-configured service cost models; and Formulation Receiving System for receiving formulation of the Service Cost Model via a user input. The outputting system includes a Trending Analysis System for market trend analysis of the service spend in relation to the service cost model.

The present system is meant for comparison of the service spends with cost projected by the service cost model; and generation of an alert when difference between the service spend and the cost projected by the Service Cost Model crosses a pre-determined threshold.

### BRIEF DESCRIPTION OF THE DRAWINGS

The invention will now be described in relation to the accompanying drawings, in which:

FIG. 1 illustrates an exemplary computer network environment

FIG. 2 illustrates an exemplary computer apparatus;

FIG. 3 illustrates an exemplary schematic of a system for spend analysis of service category;

FIG. 4 illustrates a schematic of a computer based system containing Service Cost Model;

FIG. 5 illustrates Mapping of Service Spend Category in spend analyzer module & Information Provider Module module based on Taxonomy Codes; and

FIG. 6 illustrates Service Cost Model for computer Hardware Maintenance Service.

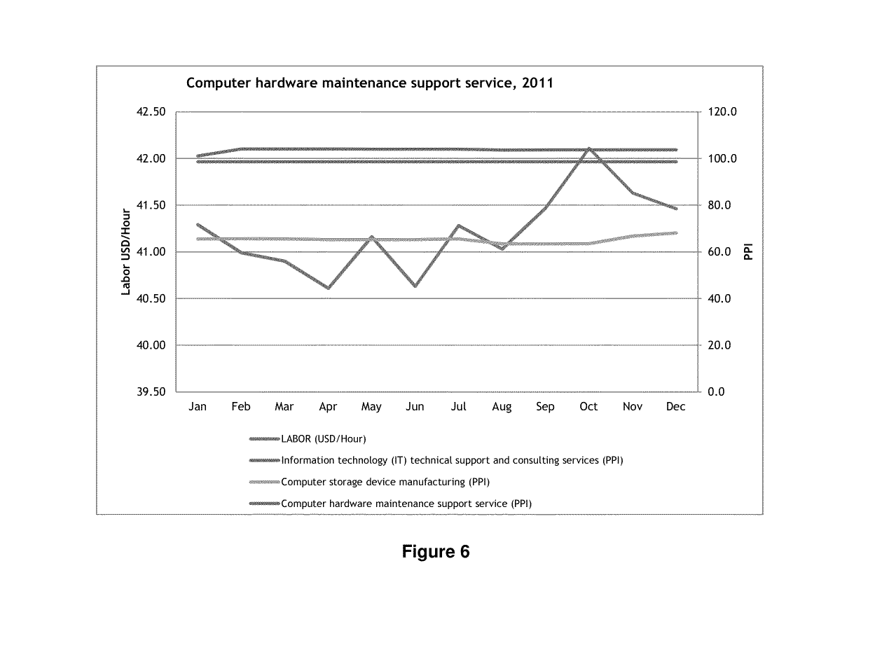

### DETAILED DESCRIPTION OF THE INVENTION

Purchasing professionals in organizations often look for ways to optimize the procurement costs (spend) for service category. These costs are often tied to labor rates and PPI (Producer Price Index) of the underlying services. As a result, market dynamics of labor rates and PPI (Producer Price Index) has significant impact on the spending for service category in the organization. Accordingly, the present invention provides techniques for spend analysis of service category, which facilitate analysis of the impact of the market dynamics of labor rates and PPI (Producer Price Index) on the service category spend. This in turn enables the purchasing professionals to take actions to optimize spend.

The following detailed description of the invention refers at various places to the accompanying drawings and specific environments, applications, platforms, examples, computer screenshots, and implementations. The detailed description is provided for thorough understanding of the present invention and is illustrative rather than limiting.

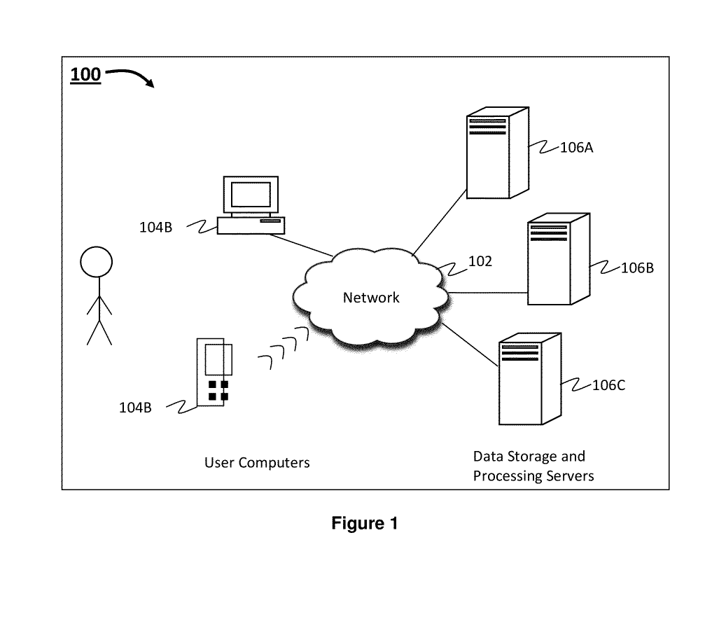

FIG. 1 illustrates an exemplary networked computer system 100 which can provide an environment to practice certain specific embodiments of the present invention. As shown in FIG. 1, multiple end user computer systems 104 and multiple server computer systems 106 can be coupled to a computer network 102. For example, the computer network 102 can be a private network of the organization. In alternative embodiment, the computer network 102 can include the local area network (LAN); and in yet an alternative embodiment it can include the Internet. The end user computer systems 104 can include without limitation desktop computers, laptop computers, personal digital assistant (PDAs), and smart phones. The computer systems 104, 106, etc. can exchange information using the computer network 102.

The servers 106 store digitized content which can be accessed (e.g., read, downloaded, searched, changed etc. as appropriate) over the computer network. A specific portion of the content is often identified using a hyperlink. The content stored in one server can also be accessed by another server and by the end user computer system. Popular techniques for accessing the content include HTTP and (HyperText Transfer Protocol) and HTTPS (HypterText Transfer Protocol Secure), though other techniques can also be used. Access to some portions of the content may require authentication and/or authorization for access.

Depending upon embodiments of the present invention, the servers 106 and the computer systems 104 can be configured to perform certain acts. For example, the servers 106 and the computer systems 104 can include software which can facilitate performing these acts. These acts can include various acts performed by the “spend analysis module”, by the “user interaction module”, for interaction between the “spend analysis module” and the “user interaction module”, for interaction between the “spend analysis module” and the “spend management module,” etc.

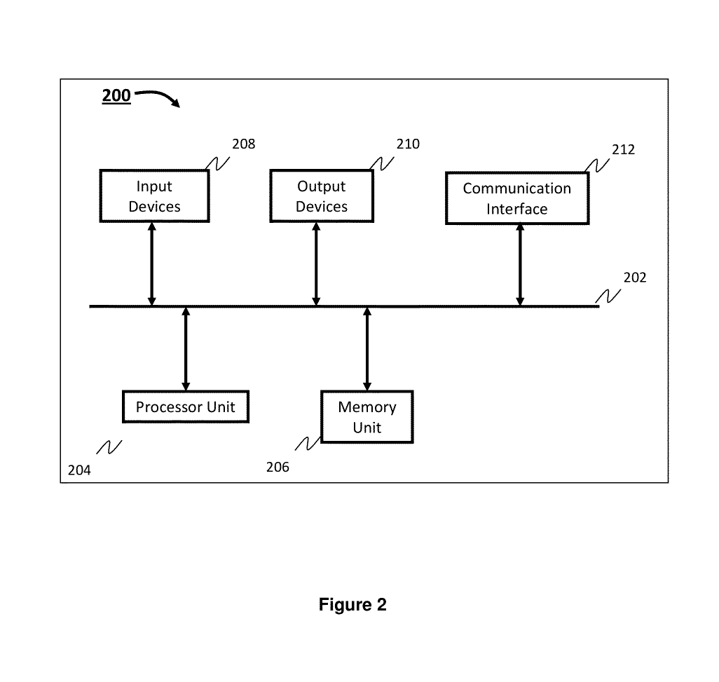

FIG. 2 illustrates an exemplary implementation of any of the servers 106 or any of the end user computer system 104, according to an embodiment of the present invention. The bus 202 permits communication among the components. The processor unit 204 may include one or more microprocessors, microcontrollers, RISC processors, CISC processors, etc. The processor unit can interpret and execute instructions. The memory unit 206 may include any type of one or more volatile storage devices, for example, random access memory (RAM). The memory unit 206 may in addition or alternatively include any type of one or more persistent storage devices, for example read only memory (ROM), read write memory, hard disc, flash memory, etc. The memory unit stores information and instructions for execution by the processor unit 204.

The input devices 208 may include one or more mechanisms that permit an operator to input information, such as a keyboard, mouse, pen, magnetic drives, optical drives, etc. The output devices 210 may include one or more mechanisms that output information to the operator, including a display, a printer, a speaker, etc. The communication interface 212 may include any transceiver mechanism that enables communication with other devices and systems via a network. For example, the communication interface can include Ethernet interface, optical network interface, wireless interface, etc.

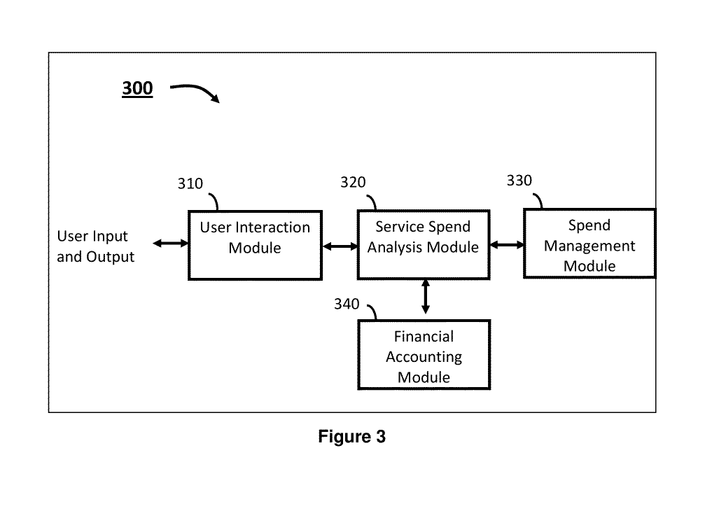

FIG. 3 illustrates an exemplary schematic 300 of a system for spend analysis of service category according to an embodiment of the present invention. As shown in FIG. 3, the system 300 comprises various modules. Each of these modules can be a hardware module, a software module, or combination thereof. Moreover, depending upon the embodiment, each of the modules can reside on a single computer system or can be distributed across a plurality of interconnected computers. The user interaction module 310 provides interface between user and machine, and performs acts such as receiving input from user and providing output to the user. The spend management module 330 typically stores procurement information, which can identify various spend categories along with their past procurement records and future estimates. The service spend analysis module 320 can perform various acts associated with analyzing the economics of the spend category.

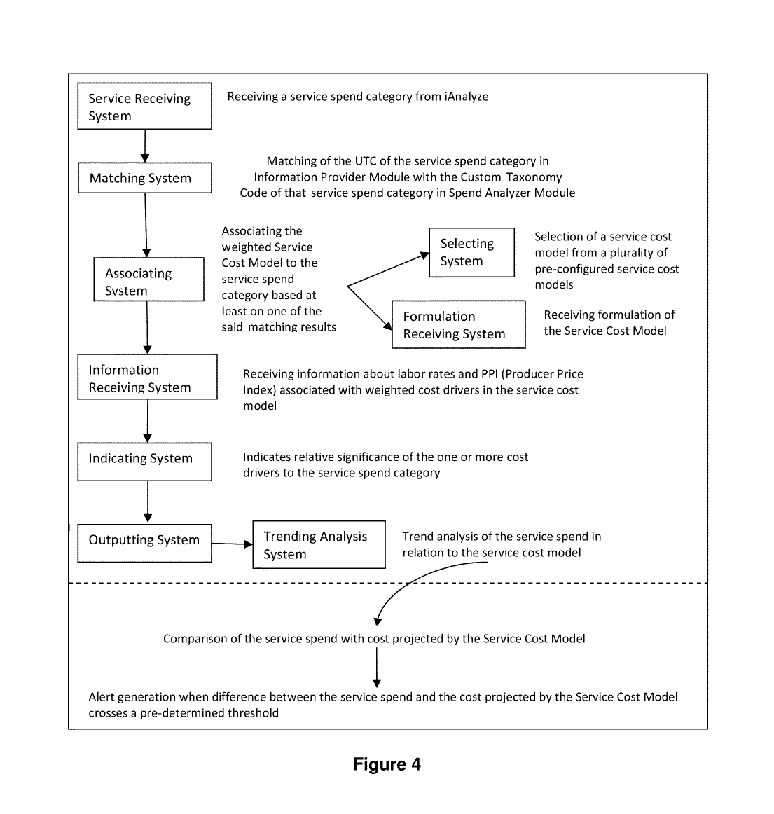

In another specific embodiment of the present invention as shown in FIG. 4, there is provided a computer based system for spend analysis of service category, the system comprises:

a processor unit;

a computer readable medium storing instructions executable by the processor unit, the computer readable medium comprising:

Service Receiving System for receiving a service spend category from Information Provider Module;

Matching System to match the UTC of the service spend category in Information Provider Module with the UTC or the Custom Taxonomy Code of that service spend category in spend analyzer module;

Associating System, meant for associating the weighted Service Cost Model to the service spend category based at least on one of the matching results, the Service Cost Model indicating one or more weighted cost drivers to the service spend category;

Information Receiving System for receiving information about labor rates and PPI (Producer Price Index) associated with at least a subset of the one or more weighted cost drivers in the service cost model; and associating the average market trend of the information about labor rates and PPI (Producer Price Index) of the one or more weighted cost contributors in the cost component model with the actual purchase trend of that service spend category for particular period of time;

Outputting System for outputting an analysis of spend associated with the service spend category in relation to the weighted service cost model, based at least in part on the average market trend of the information about labor rates and PPI (Producer Price Index).

Typically, matching of UTC of the service spend category in Information Provider Module with the Custom Taxonomy Code of that service spend category in spend analyzer module is based at least upon the one or more pre-configured matching control rules.

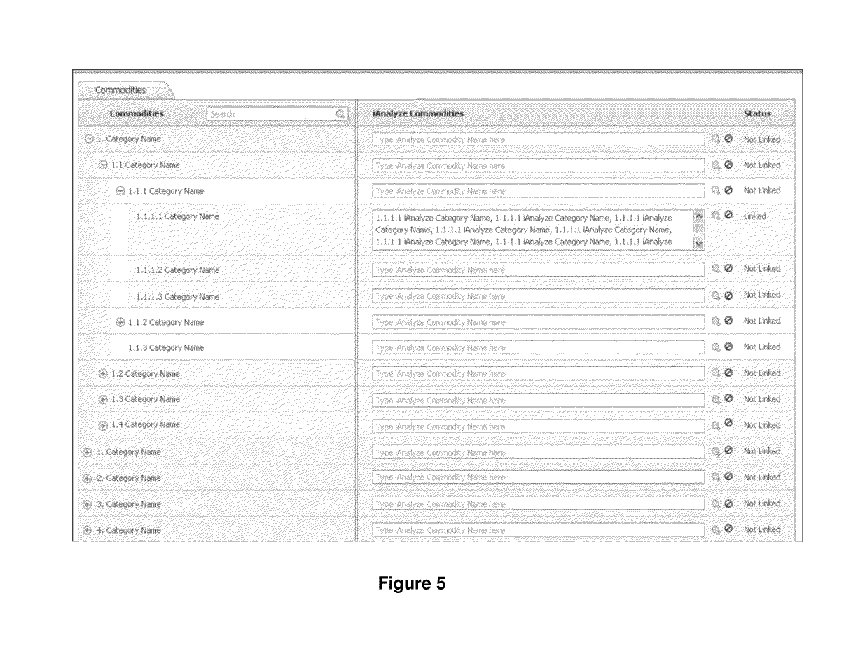

When taxonomy codes for service spend category in spend analyzer module and Information Provider Module module are UNSPC Taxonomy Code, taxonomy code of the service spend category in Information Provider Module is matched automatically with the Custom Taxonomy Code of that service spend category in spend analyzer module (FIG. 5).

When taxonomy codes of service spend category in spend analyzer module and Information Provider Module module are different, matching of UTC of the service spend category in Information Provider Module with the Custom Taxonomy Code of that service spend category in spend analyzer module is based on mapping of service spend category tree. In this case, each node of the service spend category tree in spend analyzer will be mapped to one or more nodes of the Information Provider Module commodity tree (FIG. 5).

Typically, the Service Cost Model further includes Indicating System which indicates relative significance of the one or more cost drivers to the service spend category.

Typically, the associating system includes Selecting System for selecting a Service Cost Model from a plurality of pre-configured service cost models.

Typically, the associating system includes selecting system for selecting a Service Cost Model from a plurality of pre-configured service cost models, the selection being responsive to a user input.

Typically, the associating system includes Formulation Receiving System for receiving formulation of the Service Cost Model via a user input.

Typically, the outputting system includes a Trending Analysis System for market trend analysis of the service spend in relation to the service cost model.

Typically, the computer readable medium storing further instructions executable by the processor unit performs the steps of:

comparing the service spend with cost projected by the service cost model; and

generating an alert when difference between the service spend and the cost projected by the Service Cost Model crosses a pre-determined threshold.

In the system of present invention, the Service Cost Model for a service spend category provides relative significance of cost drivers based on market indices of labor rates and PPI (Producer Price Index). This Service Cost Model further tracks the top three cost drivers of a spend category

In still another embodiment of the present invention, pre-configured Service Cost Models are provided. The user is allowed to select the Service Cost Model from these which is appropriate for the service spend category of interest. In this embodiment, the user can also modify the selected pre-configured cost model to better suit the service spend category. In an alternative embodiment, the user can formulate the Service Cost Model for the service spend category by way of selecting individual cost contributors and assigning weightages to them.

Let's take an example of Service Cost Model for Computer hardware maintenance support service. It suggest that top three cost drivers are Labor, storage, PC upgrade and their significance would be 56%, 37% & 5%, respectively. The trend for Computer hardware maintenance support service based on primary cost driver along with PPI is shown in FIG. 5

The Service Cost Model of present invention is meant to show the market trend for the cost drivers for the service spend category that is for both direct and indirect service spend categories.

The system of present invention provides flexibility to user such that allowing the user to tweak/modify the already available cost models and also further allowing the user to create new cost model.

What is claimed is:

1. A computer based system for spend analysis of service category, the system comprising:
a processor unit; and
a computer readable medium storing instructions executable by the processor unit, the computer readable medium comprising:
Service Receiving System for receiving a service spend category from Information Provider Module;
Matching System to match the UTC of the service spend category in Information Provider Module with the UTC or the Custom Taxonomy Code of that service spend category in spend analyzer module;
Associating System, meant for associating the weighted Service Cost Model to the service spend category based at least on one of the matching results, the Service Cost Model indicating one or more weighted cost drivers to the service spend category;
Information Receiving System for receiving information about labor rates and PPI (Producer Price Index) associated with at least a subset of the one or more weighted cost drivers in the service cost model; and associating the average market trend of the information about labor rates and PPI (Producer Price Index) of the one or more weighted cost contributors in the cost component model with the actual purchase trend of that service spend category for particular period of time; and
Outputting System for outputting an analysis of spend associated with the service spend category in relation to the weighted service cost model, based at least in part on the average market trend of the information about labor rates and PPI (Producer Price Index).

2. The computer based system for spend analysis of service category as claimed in claim 1, wherein, the matching of UTC of the service spend category in Information Provider Module with the Custom Taxonomy Code of that service spend category in spend analyzer module is based at least upon the one or more pre-configured matching control rules.

3. The computer based system for spend analysis of service category as claimed in claim 1, wherein, taxonomy code of the service spend category in Information Provider Module matched automatically with the taxonomy code of that service spend category in spend analyzer module; the taxonomy codes in spend analyzer module and Information Provider Module module being UNSPC Taxonomy Code.

4. The computer based system for spend analysis of service category as claimed in claim 1, wherein, matching of UTC of the service spend category in Information Provider Module with the Custom Taxonomy Code of that service spend category in spend analyzer module based on mapping of service spend category tree.

5. The computer based system for spend analysis of service category as claimed in claim 1, wherein, the system further includes Indicating System which indicates relative significance of the one or more cost drivers to the service spend category.

6. The computer based system for spend analysis of service category as claimed in claim 1, wherein, the associating system includes Selecting System for selecting a Service Cost Model from a plurality of pre-configured service cost models, the selection being responsive to a user input.

7. The computer based system for spend analysis of service category as claimed in claim 1, wherein, the associating system includes Formulation Receiving System for receiving formulation of the Service Cost Model via a user input.

8. The computer based system for spend analysis of service category as claimed in claim 1, wherein, the outputting system includes a Trending Analysis System for market trend analysis of the service spend in relation to the Service Cost Model.

9. The computer based system for spend analysis of service category as claimed in claim 1, wherein, the computer readable medium storing further instructions executable by the processor unit to perform the steps of:
comparing the service spend with cost projected by the service cost model; and
generating an alert when difference between the service spend and the cost projected by the Service Cost Model crosses a pre-determined threshold.

10. The computer based system for spend analysis of service category as claimed in claim 1, wherein, the Service Cost Model provides relative significance of cost drivers based on market indices of labor rates and PPI (Producer Price Index); the Service Cost Model tracks the top three cost drivers of a service spend category.

11. The computer based system for spend analysis of service category as claimed in claim 1, wherein, the Service Cost Model meant to show the market trend for the cost drivers for the service spend category.

12. The computer based system for spend analysis of service category as claimed in claim 1, wherein, the Service Cost Model further meant to show the market trend of cost drivers for both direct and indirect service spend categories.

13. The computer based system for spend analysis of service category as claimed in claim 1, wherein, the system provides flexibility to user such that allowing the user to tweak/modify the already available cost models and also further allowing the user to create new cost model.

14. A method for spend analysis of service category, the method comprising steps of:
receiving a service spend category from Information Provider Module;
matching of the UTC of the service spend category in Information Provider Module with the UTC or the Custom Taxonomy Code of that service spend category in spend analyzer module;
associating the weighted Service Cost Model to the service spend category based at least on one of the matching results, the Service Cost Model indicating one or more weighted cost drivers to the service spend category;
receiving information about labor rates and PPI (Producer Price Index) associated with at least a subset of the one or more weighted cost drivers in the service cost model; and associating the average market trend of the information about labor rates and PPI (Producer Price Index) of the one or more weighted cost contributors in the cost component model with the actual purchase trend of that service spend category for particular period of time; and
outputting an analysis of spend associated with the service spend category in relation to the weighted service cost model, based at least in part on the average market trend of the information about labor rates and PPI (Producer Price Index).

15. The method for spend analysis of service category as claimed in claim 14, wherein, matching of UTC of the service spend category in Information Provider Module with the Custom Taxonomy Code of that service spend category in spend analyzer module is based at least upon the one or more pre-configured matching control rules.

16. The method for spend analysis of service category as claimed in claim 14, wherein, taxonomy code of the service spend category in Information Provider Module matched automatically with the taxonomy code of that service spend category in spend analyzer module;
the taxonomy codes in spend analyzer module and Information Provider Module module being UNSPC Taxonomy Code.

17. The method for spend analysis of service category as claimed in claim 14, wherein, matching of UTC of the service spend category in Information Provider Module with the Custom Taxonomy Code of that service spend category in spend analyzer module based on mapping of service spend category tree.

18. The method for spend analysis of service category as claimed in claim 14, wherein, the method involved in the Service Cost Model further indicates relative significance of the one or more cost drivers to the service spend category.

19. The method for spend analysis of service category as claimed in claim 14, wherein, the method includes selecting a Service Cost Model from a plurality of pre-configured service cost models, the selection being responsive to a user input.

20. The method for spend analysis of service category as claimed in claim 14, wherein, the method includes receiving formulation of the Service Cost Model via a user input.

21. The method for spend analysis of service category as claimed in claim 14, wherein, the analysis includes a market trend analysis of spend for service category in relation to the service cost model.

22. The method for spend analysis of service category as claimed in claim 14, wherein, the method further comprising:
comparing the service spend with cost projected by the service cost model; and
generating an alert when difference between the service spend and the cost projected by the Service Cost Model crosses a pre-determined threshold.

23. The method for spend analysis of service category as claimed in claim 14, wherein, the method provides relative significance of cost drivers based on market indices of labor rates and PPI (Producer Price Index); the Service Cost Model tracks the top three cost drivers of a service spend category.

24. The method for spend analysis of service category as claimed in claim 14, wherein, the method meant to show the market trend for the cost drivers for service spend category.

25. The method for spend analysis of service category as claimed in claim 14, wherein, the method meant to show the market trend of the cost drivers for both direct and indirect service spend categories.

26. The method for spend analysis of service category as claimed in claim 14, wherein, the method provides flexibility to user such that allowing the user to tweak/modify the already available cost models and also further allowing the user to create new cost model.
